(19) United States
(12) Patent Application Publication
(10) Pub. No.: US 2024/0256955 A1
(43) Pub. Date: Aug. 1, 2024

(54) AUTOMATED DATASET REDUCTION BASED ON USE OF EXPLAINABILITY TECHNIQUES

(71) Applicant: Capital One Services, LLC, McLean, VA (US)

(72) Inventors: Jeremy Goodsitt, Champaign, IL (US); Austin Walters, Savoy, IL (US); Galen Rafferty, Mahomet, IL (US); Anh Truong, Champaign, IL (US); Grant Eden, San Francisco, CA (US)

(21) Appl. No.: 18/163,162

(22) Filed: Feb. 1, 2023

(51) Int. Cl. G06N 20/00

(52) U.S. Cl. CPC G06N 20/00

(57) ABSTRACT

Systems, methods, and apparatuses for automatically generating reduced training datasets are described. A training dataset may be inputted into a machine learning model to train the machine learning model to output a label. The machine learning model may comprise nodes, and each of the nodes may be associated with a weight. Based on datapoints, changes to the weight associated with each node of the plurality of nodes may be determined. Using model explainability techniques and based on the changes to the weight associated with each node of the plurality of nodes, pathways that decrease an accuracy of the machine learning model are identified. A first set of the datapoints that correlate with pathways that decrease the accuracy of the machine learning model outputting the label may be determined. Furthermore, the first set of the datapoints may be removed from the training dataset to generate a reduced training dataset.

### FIELD OF USE

Aspects of the disclosure relate generally to an automated method of reducing the size of a dataset used to train a machine learning model. More specifically, aspects of the disclosure provide for the automatic intake of a training dataset that is reduced in size based on use of explainability techniques and identification of machine learning model pathways that may decrease the accuracy of a machine learning model's output.

### BACKGROUND

Training machine learning models can be a time consuming process that involves a significant amount of manual review and multiple rounds of training. Further, training a machine learning model may require a large amount of training data some of which may not significantly contribute to improving the accuracy of the machine learning model. Some training data may even have a deleterious effect on the performance of a machine learning model and excluding such data may be beneficial. However, the process of identifying training data that impacts the pathways, nodes, and weighting of a machine learning model is difficult, in addition to being time consuming and resource intensive. Accordingly, there is a need to accurately reduce the size of a training dataset in a manner that does not also reduce the accuracy of the machine learning model.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may address these and other problems, and generally improve the effectiveness with which a training dataset may be reduced.

Aspects described herein may allow for automatic methods, systems, non-transitory machine-readable media, and devices for the generation of a reduced training dataset for use by a machine learning model. A reduced training dataset generated using the techniques described herein may be significantly smaller than the original training dataset from which it is derived, while maintaining the accuracy of the machine learning model that uses the reduced training dataset instead of the original training dataset. Generation of a reduced training dataset may also have the effect of reducing the storage space needed to store large training datasets. Additionally, large training datasets may require a greater amount of time and computational resources to process than smaller training datasets. As a result, a reduction in the size of a training dataset could reduce the time and computational resources that a machine learning model uses to process the reduced training dataset. The aspects described herein may use explainability techniques to determine pathways of a machine learning model that decrease the accuracy of the machine learning model. Correlating those pathways with datapoints of a training dataset, and eliminating those datapoints from the training dataset may allow for the generation of a reduced training dataset that is smaller without sacrificing the accuracy of the machine learning model's output.

More particularly, some aspects described herein may provide a computer-implemented method for generating a reduced training dataset. The computer-implemented method may comprise inputting, by a computing device, a training dataset into a machine learning model to train the machine learning model to output a label. The machine learning model may comprise a plurality of nodes and each node, of the plurality of nodes, is associated with a weight. The computer-implemented method may comprise determining, based on one or more datapoints of the training dataset, one or more changes to the weight associated with each node of the plurality of nodes. The computer-implemented method may comprise identifying, using one or more model explainability techniques and based on the one or more changes to the weight associated with each node of the plurality of nodes, one or more pathways that decrease an accuracy of the machine learning model outputting the label. The computer-implemented method may comprise determining a first set of the one or more datapoints that correlate with the one or more pathways that decrease the accuracy of the machine learning model outputting the label. Furthermore, the computer-implemented method may comprise removing the first set of the one or more datapoints from the training dataset to generate a reduced training dataset.

According to some aspects described herein, the computer-implemented method may comprise inputting the reduced training dataset into the machine learning model to determine whether the machine learning model outputs the label. Further, the computer-implemented method may comprise comparing a first label outputted by the machine learning model trained on the training dataset with a second label outputted by the machine learning model trained on the training dataset to determine whether the reduced training dataset causes the machine learning model to render a determination at least as accurate as the training dataset. Further, the computer-implemented method may comprise, in response to a determination that the reduced training dataset causes the machine learning model to render a determination at least as accurate as the training dataset, validating the reduced training dataset.

According to some aspects described herein, the computer-implemented method may comprise identifying, using the one or more model explainability techniques and the one or more changes to the weight associated with each node of the plurality of nodes, one or more second pathways, wherein the one or more second pathways increase the accuracy of the machine learning model outputting the label. The computer-implemented method may comprise determining a second set of the one or more datapoints that correlate with the one or more second pathways. The computer-implemented method may comprise generating a second reduced training dataset comprising the second set of the one or more datapoints.

According to some aspects described herein, the training dataset may be input into the machine learning model over a plurality of epochs. Further, the computer-implemented method may comprise determining the first set of the one or more datapoints that causes the one or more pathways to have a net decrease in outputting the label over the plurality of epochs.

According to some aspects described herein, determining the first set of the one or more datapoints that correlate with the one or more pathways that decrease the accuracy of the machine learning model outputting the label may further comprise determining that the first set of the one or more datapoints causes the weight of each node associated with the one or more pathways to change by more than a threshold amount.

The one or more changes may comprise at least one of a magnitude by which the weight associated with each node of the plurality of nodes changes or a direction in which the weight associated with each node of the plurality of nodes changes. Each of the one or more pathways may comprise a plurality of nodes that are not used in a determination to output the label based on the training dataset inputted into the machine learning model. The accuracy of the machine learning model may be based on at least one of a classification accuracy of the machine learning model or a logarithmic loss of the machine learning model.

Further, the one or more model explainability techniques may comprise at least one of a local interpretable model-agnostic explanations technique or a Shapley additive explanations technique.

According to some aspects described herein, the computer-implemented method may comprise receiving, by the computing device, feedback associated with the one or more actions, wherein the feedback comprises an indication of which of the one or more actions were implemented or results associated with the one or more actions. Further, the computer-implemented method may comprise training the one or more machine learning models based at least in part on the feedback.

Corresponding apparatuses, devices, systems, and computer-readable media (e.g., non-transitory computer readable media) are also within the scope of the disclosure. By reducing the size of the training dataset without diminishing the accuracy of the machine learning model, the benefits of faster, less resource intensive training may be achieved.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a computing system that may be used to implement one or more aspects of the disclosure in accordance with one or more illustrative aspects discussed herein;

FIG. 2 illustrates an example of a pathway of a machine learning model according to one or more aspects of the disclosure;

FIG. 3 illustrates an example of a training dataset and a reduced training dataset according to one or more aspects of the disclosure;

FIG. 4 illustrates an example of an image that may be used as a datapoint of a training dataset used to train a machine learning model according to one or more aspects of the disclosure;

FIG. 5 illustrates an example of text that may be used as a training datapoint of a training dataset used to train a machine learning model according to one or more aspects of the disclosure;

FIG. 6 illustrates an example of tabular data that may be used as a training datapoint of a training dataset used to train a machine learning model according to one or more aspects of the disclosure;

FIG. 7 illustrates an example flow chart for a method of generating a reduced training dataset according to one or more aspects of the disclosure;

FIG. 8 illustrates an example flow chart for a method of validating a reduced training dataset according to one or more aspects of the disclosure; and

FIG. 9 illustrates an example flow chart for a method of generating a reduced training dataset according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

The process of training a machine learning model may be labor intensive and require large training datasets that may require at least some manual preparation. Even after spending time and resources to prepare the training dataset, the effectiveness of the training dataset may only be determined retrospectively, after a great deal of time has been invested in setting up and training the machine learning model. Additionally, large training datasets may consume a significant amount of resources (e.g., energy, processing power, and/or storage space) in addition to the time that is required to process the training dataset. As such, reducing the size of a training dataset while maintaining the efficacy of the training dataset (e.g., not reducing the accuracy of the machine learning model that is trained using the dataset) may yield a host of benefits.

By way of introduction, aspects discussed herein may relate to systems, methods, and techniques for generating a reduced training dataset for use by a machine learning model. The system may train a machine learning model by inputting an initial training dataset into the machine learning model and analyzing changes to pathways, nodes, and/or weights of the machine learning model that occur as a result of the inputted dataset. For example, a machine learning model may be trained to detect objects in images by using a training dataset comprising various images. The machine learning model may be configured to receive input corresponding to a variety of visual features (e.g., curves, straight lines, edges, or portions of the image that have varying levels of brightness). As the machine learning model processes the images from the training dataset, the weights associated with the nodes of the machine learning model may be adjusted such that nodes that are determined to contribute more to the machine learning model outputting an accurate label (e.g., a label that matches an object in an image) may have their weights increased and nodes that do not contribute to the machine leaning model outputting an accurate label may have their weights decreased. Model explainability techniques may be used to identify pathways (e.g., contiguous sets of nodes from a node that receives input from the training dataset to a node that outputs a label) that decrease the accuracy of the machine learning model generating a label (e.g., a label that matches a ground truth label). Further, the identified pathways may be correlated with one or more images from the training dataset and a reduced training dataset may be generated by removing those images from the initial training dataset. This reduced training dataset may be more effective than the initial training dataset. Further, the reduced training dataset may speed up the process of training machine learning models and reduce the likelihood that the training data may negatively impact the accuracy of the machine learning model. As such, by reducing the size of the training dataset without diminishing the accuracy of the machine learning model, the benefits of faster, less resource intensive training may be achieved.

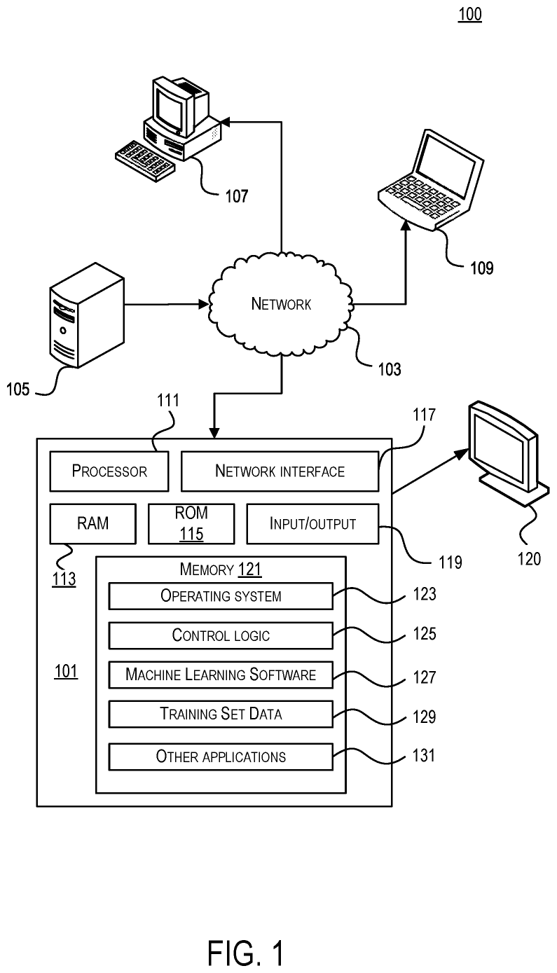

Before discussing these concepts in greater detail, however, several examples of a computing device that may be used in implementing and/or otherwise providing various aspects of the disclosure will first be discussed with respect to FIG. 1.

FIG. 1 illustrates an example of a computing system 100 that may be used to implement one or more illustrative aspects discussed herein. For example, computing system 100 may in some instances, implement one or more aspects of the disclosure by reading and/or executing instructions and performing one or more actions based on the instructions. In some instances, computing system 100 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing system 100 may in some instances, operate in a standalone environment. In others, computing system 100 may operate in a networked environment. As shown in FIG. 1, various computing devices including computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Computing devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, stylus, touch screen, camera, microphone, display device, audio output device including a loudspeaker, printer, etc.), and memory 121. Processor 111 may include one or more computer processing units (CPUs), graphical processing units (GPUs), and/or other processing units such as a processor adapted to perform computations associated with machine learning. Input/output interfaces 119 may include a variety of interface units and drives for reading, writing, displaying, and/or printing data or files. Input/output interfaces 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning model 127, training set data 129, and other applications 131. Control logic 125 may be incorporated in and may be a part of machine learning model 127. The machine learning model 127 may be configured and/or trained to perform any of the operations described herein including outputting a label. Further, the machine learning model 127 may for example comprise a plurality of nodes, with each node being associated with a weight that may be adjusted based on input which may comprise a training dataset. In other embodiments, computing device 101 may include two or more of any and/or all of these components (e.g., two or more processors, two or more memories, etc.) and/or other components and/or subsystems not illustrated here.

Computing devices 105, 107, 109 may have similar or different architecture as described with respect to computing device 101. Those of skill in the art will appreciate that the functionality of computing device 101 (or computing device 105, computing device 107, computing device 109) as described herein may be spread across multiple data processing devices, for example, to distribute processing load across multiple computers, to segregate transactions based on geographic location, user access level, quality of service (QoS), etc. For example, the computing devices 101, 105, 107, 109, and others may operate in concert to provide parallel computing features in support of the operation of control logic 125 and/or machine learning model 127.

One or more aspects discussed herein may be embodied in computer-usable or readable data and/or computer-executable instructions, such as in one or more program modules, executed by one or more computers or other devices as described herein. By way of example, one or more aspects discussed herein may comprise a computing device, comprising: one or more processors; and memory storing instructions that, when executed by the one or more processors, cause the computing device to perform one or more operations discussed herein. By way of further example, one or more aspects discussed herein may comprise a non-transitory machine-readable medium storing instructions that, when executed by one or more processors, cause the one or more processors to perform one or more steps and/or one or more operations discussed herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium (e.g., a non-transitory machine-readable medium) such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Having discussed several examples of computing devices which may be used to implement some aspects as discussed further below, discussion will now turn to systems, apparatuses, and methods for generating a reduced training dataset.

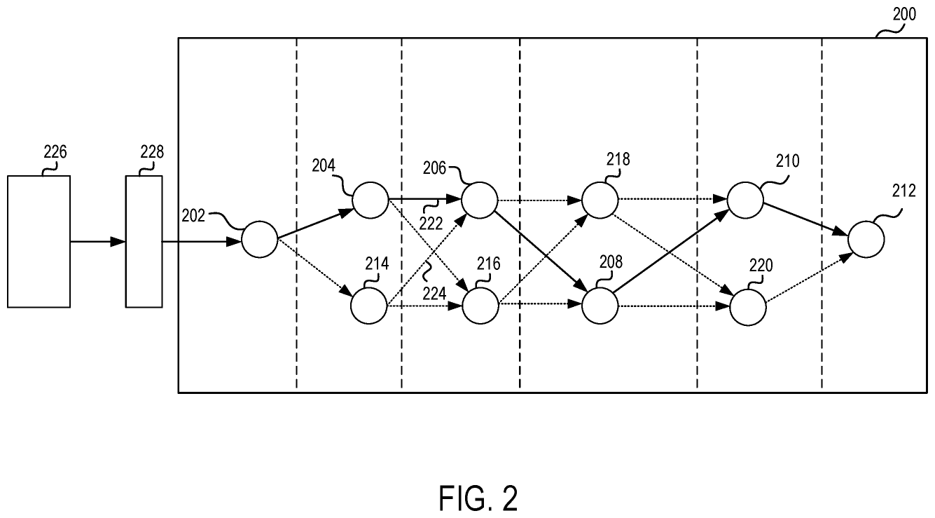

FIG. 2 illustrates an example of a nodes of a machine learning model according to one or more aspects of the disclosure that may be implemented on the computing system 100 illustrated in FIG. 1, according to a possible embodiment of the invention.

The machine learning model 200 (e.g., a machine learning model that may be similarly configured to the machine learning model 127 and/or possess the functionality and/or capabilities of the machine learning model 127) may include a plurality of nodes 202-220. For example, the machine learning model 200 may be a convolutional neural network that comprises a plurality of nodes that have connections associated with weights that are adjusted as the machine learning model 200 is trained. Further, each of the plurality of nodes may be connected (e.g., the connection 222 that connects the node 204 to the node 206) to one or more other nodes and may be configured to receive an input and/or generate an output. The input received by a node may be based on a datapoint (e.g., an image or a document) that is part of a dataset (e.g., a training dataset) or an output from another node. A feature vector may be generated based on a datapoint, and features of the feature vector may be used as inputs to various nodes that are configured to receive a certain type of feature as an input. For example, if the datapoint is an image, the feature vector for the image may comprise information associated with a plurality of visual features of the image. Further, the visual features represented in the feature vector may be associated with features of a particular portion of the image (e.g., a particular pixel or group of pixels) including color information (e.g., an RGB value and/or brightness indicating the color of a particular pixel or group of pixels of an image). In this example, the node 202 may be configured to receive input based on a single feature from a feature vector 228 that represents the visual features of a datapoint 226 (e.g., an image).

Additionally, one or more nodes of the plurality of nodes may be configured to receive input from one or more other nodes to which the node is connected (e.g., a machine learning model with three layers may comprise a node in a second layer that may receive input from another node in the first layer and generate input for a node in the third layer). For example, the node 204 may receive input from the node 202 which generated the input to the node 204 based on the input from the feature vector 228. The node 204 may then output to node 206 and/or node 216.

Each of the nodes 202-220 may be associated with a weight and the weight associated with a node may modify the input that is provided to a connected node. For example, the node 206 may receive input from the node 204 via the connection 222. Further, the node 206 may also receive input from the node 214 via the connection 224. The weight of the input from the node 204 to the node 206 may be greater than the weight of the input from the node 214 to the node 206. As a result, the contribution of node 204 to node 206 may be greater than the contribution of node 214 to node 206.

As part of training the machine learning model 200, weights associated with the plurality of nodes 202-220 may undergo one or more changes. Different nodes may be configured to receive different features as input and the weight associated with nodes that contribute to the machine learning model 200 outputting an accurate label (e.g., a label that matches a ground truth label) may be increased and the nodes that do not contribute to the machine learning model 200 outputting an accurate label may be decreased. As such, the nodes that make a relatively greater contribution to increasing the accuracy of the machine learning model 200 outputting a label may have a greater weight than nodes that make a relatively smaller contribution to the accuracy of the machine learning model outputting a label.

For example, if nodes 202-220 are part of a machine learning model that is used to detect a particular class of object in an image (e.g., a machine learning model trained to detect forged checks), each of the nodes 202-220 may be associated with some feature (e.g., visual feature) of the image that is provided as input. Over the course of training the machine learning model, the nodes that are associated with identifying features that make a greater contribution to detecting forged checks may be weighted more heavily than the nodes that make less of a contribution to detecting forged checks.

As noted above, a pathway may comprise a set of nodes that include at least a first node, that receives input of a datapoint, and a second node, that outputs a label for the datapoint. For example, the nodes 202, 204, 206, 208, 210, and 212 comprise a first pathway (as indicated by the solid lines connecting the nodes) and the nodes 202, 214, 216, 218, 220, and 212 comprise a second pathway (as indicated by the broken lines), different from the first pathway. Different sets of nodes may comprise different pathways and different pathways may be correlated with different levels of accuracy with respect to the machine learning model 200 outputting labels. The first pathway represents the pathway with the greatest weights between connected nodes that produces the desired label as output.

In contrast with the first pathway, the second pathway may represent a pathway with weights that are different (e.g., less) than the weights of the first pathway. Accordingly, an output via the second pathway may produce a label with a lower accuracy score. Alternatively, an output via the second pathway may not produce the desired label as output. For example, the weight of the connection between the node 202 and the node 204 in the first pathway may be greater than the weight of the connection between the node 202 and the node 214 in the second pathway. Further, each of the weights of the connections between the nodes of the first pathway may be greater than the weights between alternative connections between nodes in the second pathway (e.g., the connection between the node 206 and the node 208 may be greater than the weight of the connection between the node 206 and the node 218).

In this example, the first pathway, comprising the nodes 202, 204, 206, 208, 210, and 212, may result in an increase in the accuracy of the machine learning model 200 outputting a label (e.g., an increase in the rate of accurately detecting a forged check). In contrast, the second pathway, comprising the nodes 202, 214, 216, 218, 229, and 212, may result in a decrease in the accuracy of the machine learning model 200 outputting a label (e.g., a decrease in the rate of accurately detecting a forged check or an increase in the rate of accurately detecting a forged check that is less than the increase achieved using the first pathway). As will be discussed in greater detail below, if the datapoint 226 is correlated with the second pathway, the datapoint 226 may be determined to adversely affect the accuracy of the machine learning model outputting a label. As a result, the datapoint 226 may be removed from a training dataset that is used to train the machine learning model 200. Using the techniques described herein, a reduced training dataset that does not include the datapoint 226 may be generated.

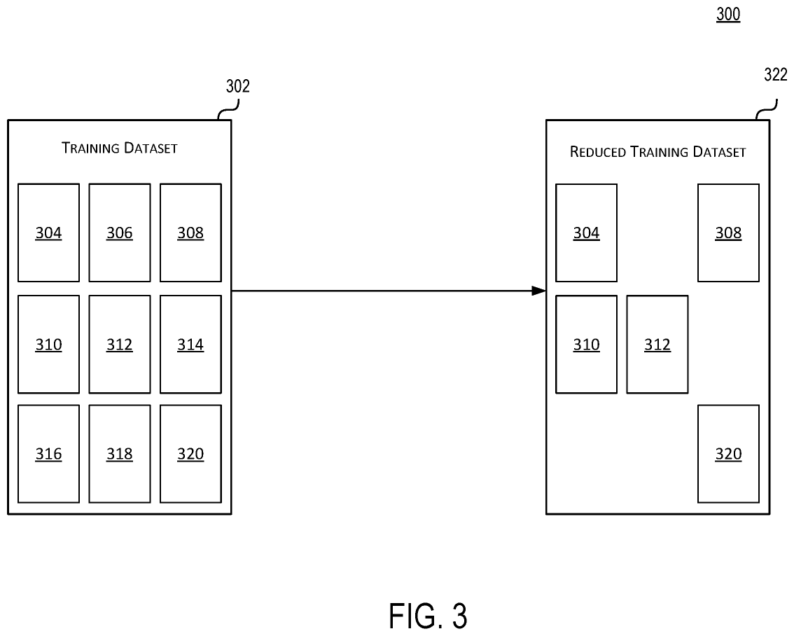

FIG. 3 illustrates an example of generating a reduced training dataset according to one or more aspects of the disclosure that may be implemented on the computing system 100 illustrated in FIG. 1, according to a possible embodiment of the invention.

The training dataset 302 comprises the datapoints 304-320. For example, each of the datapoints 304-320 (e.g., datapoints including a customer's birthday, primary account branch location, credit rating, account balance over some time period, etc.) may comprise a consumer data file that may be used to train a machine learning model to determine (e.g., identify) the consumers that should receive offers to increase the limit on their lines of credit. Using the techniques described herein, a reduced training dataset 322 may be generated. For example, in the process of training a machine learning model, pathways of the machine learning model that decrease the accuracy of the machine learning model (e.g., pathways that result in offers to increase the credit limit of consumers that should not qualify for a credit limit increase; pathways that fail to identify consumers that should receive a credit limit increase) may be determined. The datapoints 306, and 314-318 may be associated with a consumer's birthday (e.g., the day and month on which a consumer was born) or the primary branch location for the consumer. As such, the pathways that decrease the accuracy of the machine learning model may be correlated with the datapoints 306, and 314-318). As a result, the datapoints 306, and 314-318 may be removed from the training dataset 302 in order to generate the reduced training dataset 322 comprising the datapoints 304, 308, 312, and/or 320. The reduced training dataset 322 may be smaller in size and may train the machine learning model without reducing the accuracy of the machine learning model.

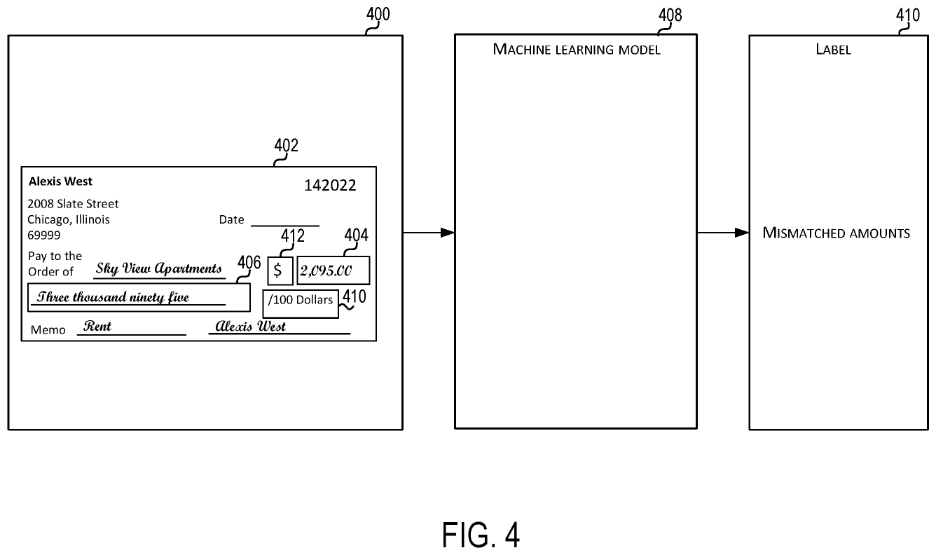

FIG. 4 illustrates an example of an image that may be used as a datapoint in a training dataset according to one or more aspects of the disclosure that may be implemented on the computing system 100 illustrated in FIG. 1, according to a possible embodiment of the invention.

The datapoint 400 may include an image of a check 402 that is used to train a machine learning model 408 (e.g., a machine learning model that is similarly configured to the machine learning model 127 and which may possess the functionality and/or capabilities of the machine learning model 127) to detect discrepancies between a numerical amount 404 and a written amount 406 that are indicated on the check 402. The machine learning model 408 may determine discrepancies in a check by performing operations including image analysis and/or natural language processing to detect fields for the numerical amount and written amount. Further, the machine-learning model 408 may perform operations to detect and/or recognize values that are adjacent to the detected fields. For example, the machine learning model 408 may detect the values adjacent to the numerical amount field and written amount field, recognize the numbers adjacent to the numerical amount field, and/or recognize the characters adjacent to the written amount field. The machine learning model 408 may then determine whether the value of the recognized numbers matches the value represented by the recognized characters.

When the machine learning model 408 determines that the value of the numbers matches the value represented by the characters, the machine learning model may output a label indicating “MATCHING AMOUNTS.” When the machine learning model 408 determines that the value of the numbers does not match the value represented by the characters, the machine learning model may output the label 410 which indicates “MISMATCHED AMOUNTS.” As shown in this example, when the datapoint 400 is provided as input to the machine learning model 408, the machine learning model 408 may detect that the value of the numerical amount 404 (e.g., “2,095”) does not match the value of the written amount 406 (e.g., “THREE THOUSAND NINETY FIVE”) and outputs the label 410 (e.g., “MISMATCHED AMOUNTS”) which indicates that there is a mismatch between the numerical amount 404 and the written amount 406.

The datapoint 400 may have been part of a larger training dataset (e.g., a training dataset with a greater number of images than a reduced training dataset) from which other datapoints (e.g., other images of checks) were removed in order to generate the reduced training dataset that the datapoint 400 is a part of and which was used to train the machine learning model 408. Inclusion of the datapoint 400 in the reduced training dataset may be a result of operations including the determination of pathways of the machine learning model 408 that decrease the accuracy of the machine learning model 408 outputting labels (e.g., outputting a label that indicates a mismatched amount when the numerical amount and written amount in an image match) and correlation of those pathways to datapoints other than the datapoint 400. Further, the datapoints correlated with the pathways that decrease the accuracy of the machine learning model 408 outputting labels may include other images in which features of the image resulted in false positive labels (e.g., a matching amount label being outputted when there is a mismatch between the numerical amount and written amount) and/or false negative labels (e.g., a mismatched amount label being outputted when there is no mismatch between the numerical amount and written amount).

For example, the datapoints that were removed from the larger training dataset may include datapoints comprising images in which non-numerical amount features or non-written amount features (e.g., ink blots or scratches on the check) were erroneously interpreted as numerical amounts or written amounts and used to train the machine learning model 408.

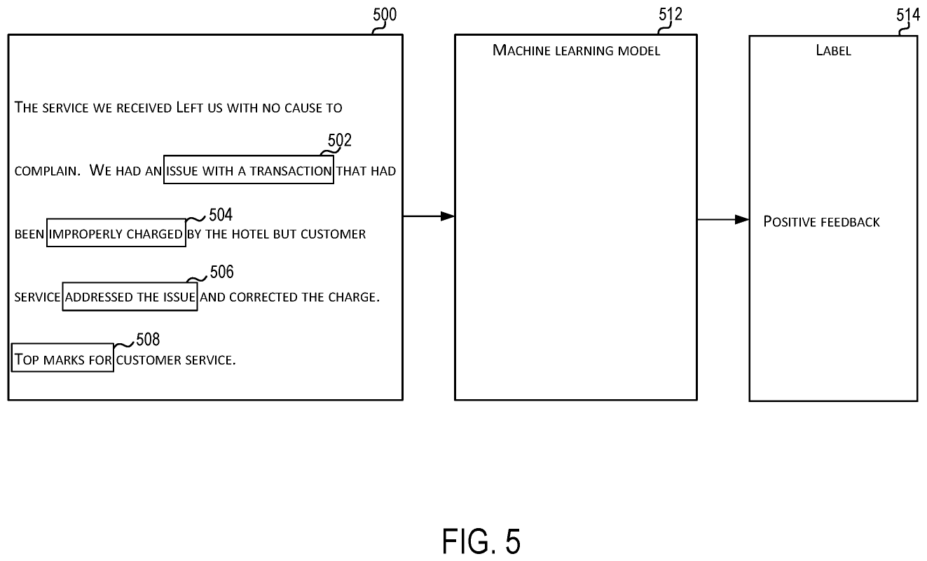

FIG. 5 illustrates an example of text that may be included as a datapoint in a training dataset according to one or more aspects of the disclosure that may be implemented on the computing system 100 illustrated in FIG. 1, according to a possible embodiment of the invention.

The datapoint 500 may include a portion of text from a customer feedback form that is used to train a machine learning model 512 (e.g., a machine learning model that may be similarly configured to the machine learning model 127 and/or possess the functionality and/or capabilities of the machine learning model 127) to determine whether the feedback indicated in the customer feedback form is positive feedback (e.g., a comment that praises customer service that was received by the customer) or a negative feedback (e.g., a comment that is critical of the quality of customer service that was received by the customer). The machine learning model 512 may perform operations to determine whether the feedback is positive or negative. For example, the machine learning model 512 may parse the text of the feedback form in order to detect key words or key phrases (e.g., words or phrases associated with positive or negative feedback). The number and type of key words and/or key phrases in the feedback form may be used to determine an aggregate approval or aggregate disapproval indicated in the feedback. For example, the feedback may be determined to be positive if the combined aggregate approval and aggregate disapproval is positive and the feedback may be determined to be negative if the combined aggregate approval and disapproval is negative. When the machine learning model 512 determines that the feedback is positive, the machine learning model may output a label indicating “POSITIVE FEEDBACK.” When the machine learning model 512 determines that the feedback is negative, the machine learning model may output a label indicating “NEGATIVE FEEDBACK.” As shown in this example, when the datapoint 500 is provided as input to the machine learning model 512, the machine learning model 512 parses the text of the feedback form, detects key words (e.g., “ADDRESSED THE ISSUE” and “TOP MARKS”), and determines that the customer feedback indicated in the customer feedback form is positive, and outputs the label 514 (e.g., “POSITIVE FEEDBACK”).

The datapoint 500 may have been part of a larger training dataset (e.g., a training dataset with a greater number of customer feedback forms than a reduced training dataset) from which other datapoints (e.g., other customer feedback forms) were removed in order to generate the reduced training dataset that the datapoint 500 is part of. The datapoint 500 may be correlated with pathways of the machine learning model 512 that increased the accuracy of the machine learning model 512 outputting labels (e.g., outputting a positive feedback label for positive customer feedback and/or outputting a negative feedback label for negative customer feedback). Further, the datapoints that were not included in the reduced training dataset may be correlated with the pathways of the machine learning model 512 that decreased the accuracy of the machine learning model 512 (e.g., outputting a positive feedback label for negative customer feedback and/or outputting a negative feedback label for positive customer feedback).

By way of further example, pathways correlated with customer feedback forms that were removed from a larger training dataset to generate the reduced training dataset may include pathways correlated with customer feedback forms in which key words that do not indicate approval or disapproval features (e.g., “The service or “customer service” indicated in the datapoint 500) are used to train the machine learning model 512 to determine an aggregate approval or aggregate disapproval indicated in the feedback. Further, pathways correlated with images that were removed from an initial training dataset to generate the reduced training dataset may include pathways correlated with customer feedback forms in which key words (e.g., “ADDRESSED THE ISSUE” and/or “TOP MARKS”) are not used to train the machine learning model to determine an aggregate approval or aggregate disapproval indicated in the feedback.

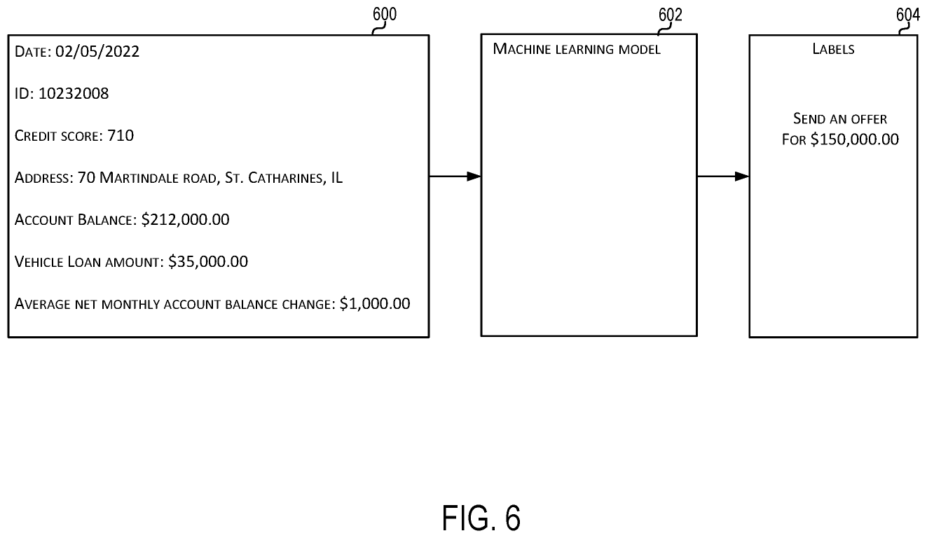

FIG. 6 illustrates an example of tabular data that may be used as a datapoint in a training dataset according to one or more aspects of the disclosure that may be implemented on the computing system 100 illustrated in FIG. 1, according to a possible embodiment of the invention.

The datapoint 600 may include consumer data that is used to train a machine learning model 602 (e.g., a machine learning model that may be similarly configured to the machine learning model 127 and/or possess the functionality and/or capabilities of the machine learning model 127) to determine whether to send an offer (e.g., an offer for a car loan) to the consumer associated with the consumer data. The machine learning model 602 may perform operations to determine whether or not to send an offer to a consumer. For example, the machine learning model 602 may perform operations including determining values associated with fields of the datapoint 600 (e.g., the credit score or the account balance) and using the values to determine a consumer score for the consumer (e.g., a consumer score that is positively correlated with the account balance and negatively correlated with the vehicle loan amount). The machine learning model 602 may also determine an offer score based on the type and value of the offer (e.g., the offer score may be positively correlated with the value of the offer). The consumer score may then be compared to the offer score. When the machine learning model 602 determines that the consumer score exceeds the offer score, the machine learning model 602 may output a label indicating “SEND OFFER.” When the machine learning model 602 determines that the consumer score exceeds the offer score, the machine learning model 602 may output the label 608 which indicates “DO NOT SEND AN OFFER.” As shown in this example, when the datapoint 600 is provided as input to the machine learning model 602, the machine learning model 602 that an offer should be send and outputs the label 604 (e.g., “SEND AN OFFER FOR $150,000.00”) which indicates that the consumer should be sent (e.g., via e-mail) an offer of $150,000.00 for a car loan.

The datapoint 600 may be part of a reduced training dataset that was generated by removing other datapoints from a larger training dataset that the datapoint 600 was also a part of. The datapoint 600 may be correlated with pathways of the machine learning model 602 that increased the accuracy of the machine learning model 602 outputting labels (e.g., outputting a label to send an offer to a consumer that is qualified to receive the offer). Further, the datapoints that were not included in the reduced training dataset may be correlated with the pathways of the machine learning model 602 that decreased the accuracy of the machine learning model 602 (e.g., outputting a label to send an offer to a consumer that is not qualified to receive the offer or fail to send an offer to a qualified consumer).

For example, pathways correlated with images that were removed from a larger training dataset to generate the reduced training dataset may include pathways correlated with consumer data in which irrelevant features of the consumer data (e.g., a consumer's ID number) make a significant contribution to training the machine learning model 602 to determine whether or not to send an offer to a consumer. Further, pathways correlated with images that were removed from an initial training dataset to generate the reduced training dataset may include pathways correlated with consumer data in which relevant features of the consumer data (e.g., the credit score or account balance) make a small contribution to determining the amount of an offer.

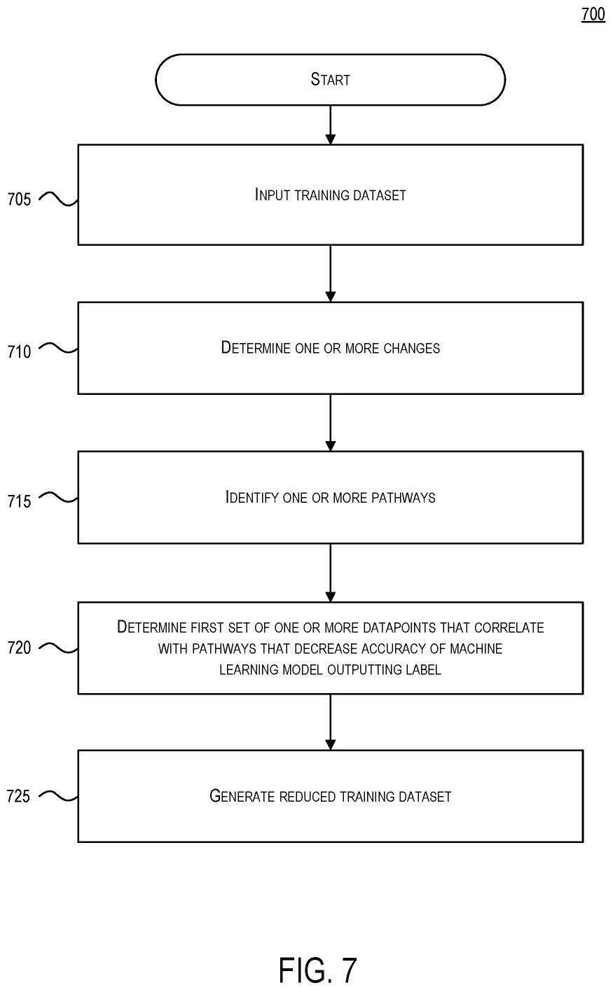

FIG. 7 illustrates an example flow chart for a method of generating a reduced training dataset according to one or more aspects of the disclosure. Method 700 may be implemented by a suitable computing system, as described further herein. For example, method 700 may be implemented by any suitable computing environment by a computing device and/or combination of computing devices, such as computing devices 101, 105, 107, and 109 of FIG. 1. Method 700 may be implemented in suitable program instructions, such as in machine learning model 127, and may operate on a suitable training set, such as training set data 129.

At step 705, the system may input a training dataset into a machine learning model (e.g., any of the machine learning models described herein including the machine learning model 127) to train the machine learning model to output a label. Further, the training dataset may comprise one or more datapoints. For example, a training dataset comprising one or more datapoints may be inputted into a machine learning model in order to configure and/or train the machine learning model to classify each datapoint. The trained machine learning model may then generate labels based on the classifications of the datapoints. By way of example, a training dataset may include images of checks. The images of checks in the training dataset may include images of checks with a payee indicated in the payee field and images of checks without a payee indicated in the payee field. Using the training dataset, a machine learning model may be trained to detect fields in images of checks and in particular to detect fields that are empty (e.g., a payee field without an accompanying payee). Based on input comprising an image of a check, the trained machine learning model may then generate labels indicating the checks that are properly filled in and the checks with fields that are empty.

The machine learning model may comprise a plurality of nodes. For example, the machine learning model may comprise a plurality of nodes similar to the plurality of nodes of the machine learning model 200 described in FIG. 2. Based on the input provided to each of the plurality of nodes, the weight associated with each of the plurality of nodes may be adjusted. For example, the magnitude of the weight of a node may be increased when the node is determined to increase the accuracy of a machine learning model outputting labels that classify datapoints (e.g., labels that match a ground truth label of a scanned image of a check) and the magnitude of the weight of the node may be decreased when the node is determined to decrease the accuracy of a machine learning model outputting labels that classify datapoints (e.g., labels that do not match a ground truth label of a scanned image of a check).

A label that is outputted by the machine learning model (e.g., a label indicating a the class of an object recognized in an image) may be compared to a ground truth label (e.g., the actual class of the object depicted in the image). For a classification task in which the label comprises a classification, the system may adjust the weighting of the plurality of nodes based on a loss function, for example, based on whether the label matches the ground truth label. The loss function may generate a loss associated with the accuracy of the label relative to the ground truth label. For a regression task in which a quantity is predicted (e.g., using customer information to predict the dollar amount of a line of credit to offer a customer), the system may adjust the weighting of the plurality of nodes based on a loss function, for example, based on the similarity between the outputted predicted quantity and the ground truth quantity. The loss function may generate a loss associated with the accuracy of the predicted quantity relative to the ground truth quantity. The nodes that make a contribution to minimizing the loss produced by the loss function may have their weights increased and the nodes that do not make a contribution to minimizing the loss may have their weights decreased.

The one or more machine learning models may include recurrent neural network models (RNN), convolutional neural network models (CNN), support-vector networks, induction of decision trees, random forests, bootstrap aggregating, k-means clustering, k-nearest neighbors (k-NN), k-medoids clustering, regression, Bayesian networks, relevance vector machine (RVM), support vector machines (SVM), generative adversarial networks (GAN), and the like. The present disclosure may utilize other statistical analysis methods, which may include multivariate or univariate statistical analysis.

The training dataset may be transferred into a memory device within a processor or computing device. Further, a machine learning model located within the processor or computing device may be configured to receive the one or more datapoints from the training dataset. Machine learning model may be previously trained, run a training program immediately subsequent to data profiling, or designed for active learning alongside the data profiling step. Training may entail one or more training dataset batches, one or more epochs, hyperparameter tuning, optimization models, and the like. Further, the training dataset may include information that is structured in different file types, including image data (e.g., JPEG, BMP, TIFF, or PNG), textual data (e.g., HyperText Markup Language (HTML), extensible Markup Language (XML), plain text, or the like); and/or tabular data (such as comma-separated values (CSV), tab-delimited file (TAB), or the like).

At step 710, the system may determine, based on one or more datapoints, one or more changes to a weight associated with each node of the plurality of nodes. For example, the system may compare a weight associated with each of the plurality of nodes prior to receiving the training dataset to a weight associated with each of the plurality of nodes after receiving the training dataset and the machine learning model outputting a label.

The one or more changes may include different ways that the weight associated with a node may be changed. Further, the one or more changes to the weight associated with each node may comprise at least one of a magnitude by which the weight associated with each node of the plurality of nodes changes; or a direction in which the weight associated with each node of the plurality of nodes changes. The magnitude of the change in the weight associated with each of the plurality of nodes may comprise an amount by which each of the plurality of nodes changed. The direction in which the weight associated with each of the plurality of nodes changes may comprise an upward direction when the weight associated with a node increases or a downward direction when the weight associated with a node decreases. For example, a node may be associated with a weight that corresponds to a numeric value (e.g., a value from one to one-hundred) and the magnitude associated with the weight of the node may increase (e.g., change in an upward direction) when the node is determined to contribute to increasing the accuracy of the machine learning model outputting a label and the magnitude associated with the weight of the node may decrease (e.g., change in a downward direction) when the node is determined to contribute to decreasing the accuracy of the machine learning model outputting the label.

Further, the machine learning model may be configured to increase the weight associated with nodes that contribute to identifying features that result in a machine learning model that more accurately outputting labels (e.g., labels that correctly identify checks without a payee indicated in the payee field) and decrease the weight of nodes that reduce the accuracy of a machine learning model outputting a label (e.g., labels that incorrectly identify a properly filled in payee field as being empty).

The one or more changes may indicate whether the weight associated with a node increased, decreased, or remained the same after receiving input. For example, a training dataset may include a datapoint that is an image of a check. A machine learning model may be configured to classify images and identify the name indicated in the payee field of the check. Further, the machine learning model may be configured to increase the weight of nodes that contribute to more accurate outputting of labels (e.g., labels that correctly identify the payee name indicated in the payee field of the check in the image).

At step 715, the system may identify, using one or more model explainability techniques and based on the one or more changes to the weight associated with each node of the plurality of nodes, one or more pathways that decrease an accuracy of the machine learning model outputting the label.

The one or more pathways may comprise a set of nodes that form a pathway from a node that receives input based on a datapoint from the training dataset to a node that generates output comprising a label. For example, the one or more pathways may comprise a contiguous plurality of nodes from an input layer of the machine learning model to an output layer of the machine learning model. The one or more model explainability techniques may comprise one or more techniques that are used to generate explanations with respect to the output (e.g., labels) that the machine learning model produces based on analysis of the one or more changes to the machine learning model (e.g., changes to the weighting of the nodes of a machine learning model) that result from input of a training dataset. The explanations generated by an explainability technique may comprise identification of the one or more pathways that change the accuracy of the machine learning model outputting the label. For example, an explainability technique may identify the portions of a datapoint (e.g., an image or document) that result in an increase in the accuracy of the machine learning model outputting a label. By determining the portions of the datapoint that increase the accuracy of the machine learning model outputting a label, the system may also determine that the remaining portions of the datapoint may decrease or not change the accuracy of the machine learning model outputting the label.

For example, if the training dataset comprises a datapoint that is an image of a check and the machine learning model is being trained to identify fields comprising a name of a bank (e.g., the typewritten name of a bank in a check) in the image of the check, the system may generate different versions of an image that comprise different combinations of one or more segments of the image. The datapoints corresponding to the segments of the image of the check may then be inputted into the machine learning model and a label comprising the name of the bank may be determined. Datapoints that comprise segments that include a field with the entire name of the bank may result in the accuracy of the machine learning model being increased (e.g., a label with the correct name of the bank is generated), datapoints that comprise segments that include a portion of the name of the bank may result in the accuracy of the machine learning model being increasing some of the time and/or decreasing some of the time, and datapoints that comprise segments that do not include any part of the name of the bank may the accuracy of the machine learning model being decreased (e.g., a label with the wrong name of the bank is generated). The system may then determine the pathways (e.g., sets of nodes from an input layer to an output layer) that correspond to the different outputs (e.g., accurate labels and inaccurate labels) including the pathways associated with the decreasing the accuracy of the machine learning model generating the label. The one or more model explainability techniques may comprise at least one of a local interpretable model-agnostic explanations technique or a Shapley additive explanations technique.

Each of the one or more pathways may comprise a plurality of nodes that are not used in a determination to output the label based on the training dataset inputted into the machine learning model. For example, when training the machine learning model, certain nodes may have a weight that is less than a threshold value. A node associated with a weight that is less than the threshold value may be determined not to contribute to the determination to output the label.

At step 720, the system may determine a first set of the one or more datapoints that correlate with the one or more pathways that decrease the accuracy of the machine learning model outputting the label. The one or more pathways that decrease the accuracy of the machine learning model may comprise one or more pathways that result in the machine learning model outputting a label that does not match a ground truth label (e.g., a machine learning model trained to recognize faces in images failing to recognize an image with a face). Further, the system may keep track of each datapoint, pathway, and/or label in order to correlate the datapoints with the pathways that decrease the accuracy of the machine learning model outputting the label.

The determination of the first set of the one or more datapoints may comprise determining that the first set of the one or more datapoints causes the weight of each node associated with the one or more pathways to change by more than a threshold amount. For example, if the weight of each node ranges from zero (0) to one hundred (100), the threshold amount may be ten (10) such that a node that changes by more than ten (10) would be determined to have exceeded the threshold amount. As a result, the first set of the one or more datapoints may be determined to comprise the one or more datapoints that cause the weight of each node associated with the one or more pathways to change by more than ten and not include the one or more datapoints that do not cause the weight of each node associated with the one or more pathways to change by more than ten.

The accuracy of the machine learning model may be based on at least one of a classification accuracy of the machine learning model or a logarithmic loss of the machine learning model. For example, if the machine learning model is configured to classify images, the classification accuracy of the machine learning model may be based on the number of correctly classified images relative to the total number of images (e.g., for a face classification machine learning model used for login security the classification accuracy may be based on the number of correctly identified faces relative to the total number of faces in the training dataset). Further, the classification accuracy may be based on the sum of the number of true positives and true negatives relative to the sum of true positives, true negatives, false positives, and false positives. For example, for a face classification machine learning model the classification accuracy could be based on the sum of correctly identified images with faces and images without faces relative to the sum of the total number of images correctly identified with faces, images without faces that were correctly identified, plus the images falsely identified as having faces and the images that have faces that were falsely identified as not having faces. By way of further example, in the case of a machine learning model that is trained to determine a credit score for a user, the logarithmic loss of the machine learning model may be based on the extent to which the label outputted by the machine learning model (e.g., the predicted credit score) diverges from a ground truth label (e.g., the actual credit score of the user).

The training dataset may be inputted into the machine learning model over a plurality of epochs. For example, the training dataset may comprise ten thousand (10,000) images and the plurality of epochs may comprise a plurality of forward and backward passes (through the machine learning model) of the entire dataset of ten thousand (10,000) images. Further, the system may determine the first set of the one or more datapoints that correlate with the one or more pathways that cause the machine learning model to have a net decrease in outputting the label over the plurality of epochs. For example, the system may determine the one or more pathways that were traversed over the plurality of epochs. The system may then determine, for each of the one or more pathways that caused a decrease in the accuracy of the machine learning model outputting the label (e.g., a label that does not match a ground truth label) after each epoch, the datapoints (e.g., images) that correspond to the one or more pathways. The system may then determine the aggregate change in the accuracy of the machine learning model outputting the label over the plurality of epochs and thereby determine the one or more datapoints that correlate with the one or more pathways that cause a net decrease in the machine learning model outputting the label.

At step 725, the system may remove the first set of the one or more datapoints from the training dataset to generate a reduced training dataset. For example, a training dataset may comprise one thousand five hundred (1500) images that are used to train a machine learning model to identify incomplete checks (e.g., checks that are missing information in certain fields of the check). The images may comprise five hundred (500) images of checks that are not incomplete and five hundred (500) images of checks that are incomplete, and five hundred (500) images of documents that are not checks. For example, some of the images of documents that are not checks may adversely affect the weighting of nodes that detect visual features associated with checks. As a result, some of the images may be removed from the training dataset in order to generate the reduced training dataset.

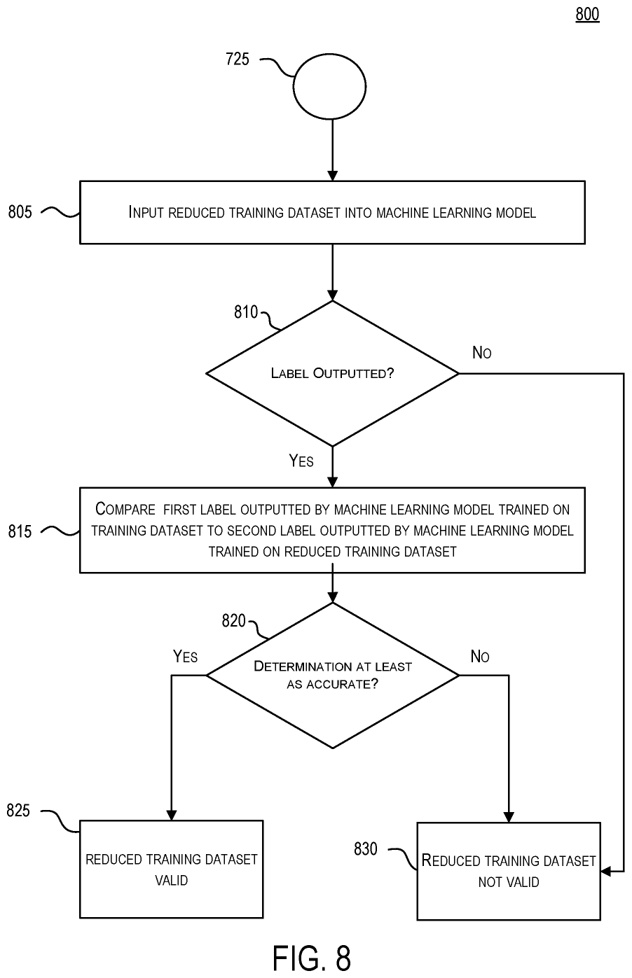

FIG. 8 illustrates an example flow chart for a method of validating a reduced training dataset according to one or more aspects of the disclosure. Method 800 may be implemented by a suitable computing system, as described further herein. For example, method 800 may be implemented by any suitable computing environment by a computing device and/or combination of computing devices, such as computing devices 101, 105, 107, and 109 of FIG. 1. Method 800 may be implemented in suitable program instructions, such as in machine learning model 127, and may operate on a suitable training set, such as training set data 129. Furthermore, one or more steps and/or one or more portions of method 800 may be incorporated into method 700.

At step 805, the system may input the reduced training dataset into the machine learning model to determine whether the machine learning model outputs the label. The reduced training dataset may be the reduced training dataset generated in step 725. For example, the training dataset may comprise images that are used to train a machine learning model to identify faces (e.g., output a label including the name of a face in an image) and the label may comprise a name associated with a face. The reduced training dataset may comprise a subset of datapoints of the training dataset that were determined not to decrease the accuracy of the machine learning model outputting labels (e.g., the name of a face). The reduced training dataset may be input into the machine learning model in order to determine whether the machine learning model outputs the label (e.g., a label indicating a name associated with a face).

At step 810, in response to a determination that the label has been outputted, step 815 may be performed. In response to a determination that the label has not been outputted, step 830 may be performed. For example, the absence of a label being outputted, an error being outputted, or a label that does not match a ground truth label being outputted may be an indication that the reduced training dataset is not valid.

At step 815, the system may compare a first label outputted by the machine learning model trained on the training dataset to a second label outputted by the machine learning model trained on the reduced training dataset to determine whether the reduced training dataset causes the machine learning model to render a determination at least as accurate as the training dataset. For example, a first datapoint (e.g., an image) may be inputted into a machine learning model that was trained using the training dataset, and which outputs a first label comprising the name associated with a face in an image. The same datapoint (e.g., the same image) may then be inputted into the same machine learning model that was trained using the reduced training dataset (e.g., a reduced training dataset comprising a subset of the training dataset) instead of the training dataset, and which outputs a second label. If the first label is accurate (e.g., the label matches a ground truth label) and the second label matches the first label then the reduced training dataset may be determined to render a determination at least as accurate as the training dataset. If the first label does not match the second label then the reduced training dataset may be determined to render a determination that is not at least as accurate as the training dataset.

At step 820, in response to a determination that the reduced training dataset causes the machine learning model to render a determination at least as accurate as the training dataset, step 825 may be performed. Further, at step 820, in response to a determination that the reduced training dataset does not cause the machine learning model to render a determination at least as accurate as the training dataset, step 830 may be performed.

At step 825, the system may determine that the reduced training dataset is valid (e.g., that a label is outputted and the label that is outputted matches a ground truth label). Further, the system may generate an indication that the reduced training data is valid. For example, the system may generate an indication that “THE REDUCED TRAINING DATASET IS VALID.”

At step 830, the system may determine that the reduced training dataset is not valid (e.g., either that a label is not outputted or that the label that is outputted does not match a ground truth label). Further, the system may generate an indication that the reduced training data is invalid. For example, the system may generate an indication that “THE REDUCED TRAINING DATASET IS NOT VALID.”

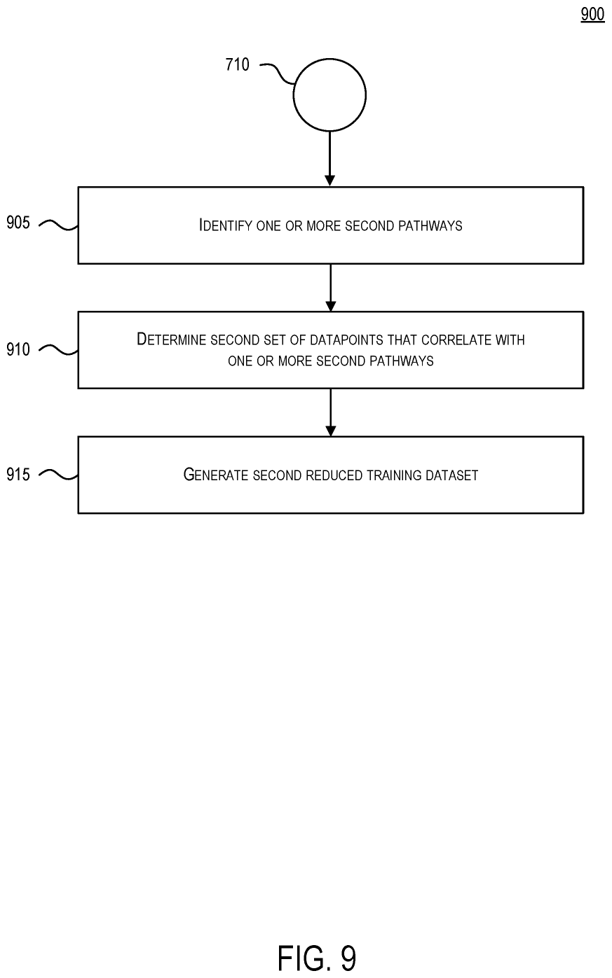

FIG. 9 illustrates an example flow chart for a method of generating a reduced training dataset according to one or more aspects of the disclosure. Method 900 may be implemented by a suitable computing system, as described further herein. For example, method 900 may be implemented by any suitable computing environment by a computing device and/or combination of computing devices, such as computing devices 101, 105, 107, and 109 of FIG. 1. Method 900 may be implemented in suitable program instructions, such as in machine learning model 127, and may operate on a suitable training set, such as training set data 129. Furthermore, one or more steps and/or one or more portions of method 900 may be incorporated into method 700.

At step 905, the system may identify, using the one or more model explainability techniques and the one or more changes to the weight associated with each node of the plurality of nodes, one or more second pathways. Step 905 may be performed subsequent to step 710 and the plurality of nodes in step 905 may be the plurality of nodes in step 710 of the machine learning model in step 705. The one or more second pathways may increase the accuracy of the machine learning model outputting the label. For example, the system may identify the one or more second pathways that increase the accuracy of the machine learning model outputting the label using the one or more explainability techniques described in step 715.

At step 910, the system may determine a second set of the one or more datapoints that correlate with the one or more second pathways. The system may determine the second set of the one or more datapoints using the techniques described in step 720. For example, the one or more second pathways that increase the accuracy of the machine learning model (e.g., the one or more second pathways identified in step 905) may comprise one or more pathways that result in the machine learning model outputting a label that matches a ground truth label (e.g., a machine learning model trained to recognize checks with incomplete fields correctly identifies a check with an incomplete field). Further, the system may keep track of each datapoint, pathway, and/or label and thereby correlate the datapoints with the one or more second pathways that increase the accuracy of the machine learning model outputting the label.

At step 915, the system may generate a second reduced training dataset. The second reduced training dataset may comprise the second set of the one or more datapoints. For example, the system may generate the second reduced training dataset by removing, from the training dataset, any datapoints that are not included in the second set of the one or more datapoints. For example, a training dataset may comprise one thousand (1000) documents that are used to train a machine learning model to identify negative user feedback. The documents may comprise documents that indicate negative feedback, documents that indicate positive feedback, and documents that do not indicate either positive or negative feedback. The second reduced training dataset may exclude the documents that do not increase the accuracy of the machine learning model outputting labels, leaving a reduced training dataset that includes only documents that increase the accuracy of the machine learning model outputting labels.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The steps of the methods described herein are described as being performed in a particular order for the purposes of discussion. A person having ordinary skill in the art will understand that the steps of any methods discussed herein may be performed in any order and that any of the steps may be omitted, combined, and/or expanded without deviating from the scope of the present disclosure. Furthermore, the methods described herein may be performed using any manner of device, system, and/or apparatus including the computing devices, computing systems, and/or computing apparatuses that are described herein.

What is claimed is:

1. A method comprising:
inputting, by a computing device, a training dataset into a machine learning model to train the machine learning model to output a label, wherein the machine learning model comprises a plurality of nodes and each node, of the plurality of nodes, is associated with a weight;
determining, based on one or more datapoints of the training dataset, one or more changes to the weight associated with each node of the plurality of nodes;
identifying, using one or more model explainability techniques and based on the one or more changes to the weight associated with each node of the plurality of nodes, one or more pathways that decrease an accuracy of the machine learning model outputting the label;
determining a first set of the one or more datapoints that correlate with the one or more pathways that decrease the accuracy of the machine learning model outputting the label; and
removing the first set of the one or more datapoints from the training dataset to generate a reduced training dataset.

2. The method of claim 1, further comprising:
inputting the reduced training dataset into the machine learning model to determine whether the machine learning model outputs the label;
comparing a first label outputted by the machine learning model trained on the training dataset to a second label outputted by the machine learning model trained on the reduced training dataset to determine whether the reduced training dataset causes the machine learning model to render a determination at least as accurate as the training dataset; and
in response to a determination that the reduced training dataset causes the machine learning model to render a determination at least as accurate as the training dataset, determining that the reduced training dataset is valid.

3. The method of claim 1, wherein the determining the first set of the one or more datapoints that correlate with the one or more pathways that decrease the accuracy of the machine learning model outputting the label further comprises:
determining that the first set of the one or more datapoints causes the weight associated with each node associated with the one or more pathways to change by more than a threshold amount.

4. The method of claim 1, wherein the one or more changes comprise at least one of:
a magnitude by which the weight associated with each node of the plurality of nodes changes; or
a direction in which the weight associated with each node of the plurality of nodes changes.

5. The method of claim 1, wherein each of the one or more pathways comprises a plurality of nodes that are not used in a determination to output the label based on the training dataset inputted into the machine learning model.

6. The method of claim 1, wherein the training dataset is input into the machine learning model over a plurality of epochs, and further comprising:
determining the first set of the one or more datapoints that correlate with the one or more pathways that cause the machine learning model to have a net decrease in outputting the label over the plurality of epochs.

7. The method of claim 1, wherein the accuracy of the machine learning model is based on at least one of:
a classification accuracy of the machine learning model; or
a logarithmic loss of the machine learning model.

8. The method of claim 1, further comprising:
identifying, using the one or more model explainability techniques and the one or more changes to the weight associated with each node of the plurality of nodes, one or more second pathways, wherein the one or more second pathways increase the accuracy of the machine learning model outputting the label;
determining a second set of the one or more datapoints that correlate with the one or more second pathways; and
generating a second reduced training dataset comprising the second set of the one or more datapoints.

9. The method of claim 1, wherein the one or more model explainability techniques comprise at least one of:
a local interpretable model-agnostic explanations technique; or
a Shapley additive explanations technique.

10. A non-transitory machine-readable medium storing instructions that, when executed by one or more processors, cause the one or more processors to perform steps comprising:
inputting a training dataset into a machine learning model to train the machine learning model to output a label, wherein the machine learning model comprises a plurality of nodes and each node, of the plurality of nodes, is associated with a weight;
determining, based on one or more datapoints of the training dataset, one or more changes to the weight associated with each node of the plurality of nodes;
identifying, using one or more model explainability techniques and based on the one or more changes to the weight associated with each node of the plurality of nodes, one or more pathways that decrease an accuracy of the machine learning model outputting the label;
determining a first set of the one or more datapoints that correlate with the one or more pathways that decrease the accuracy of the machine learning model outputting the label; and
removing the first set of the one or more datapoints from the training dataset to generate a reduced training dataset.

11. The non-transitory machine-readable medium of claim 10, wherein the instructions that, when executed by one or more processors, further cause the one or more processors to perform steps comprising:
inputting the reduced training dataset into the machine learning model to determine whether the machine learning model outputs the label;
comparing a first label outputted by the machine learning model trained on the training dataset with a second label outputted by the machine learning model trained on the training dataset to determine whether the reduced training dataset causes the machine learning model to render a determination at least as accurate as the training dataset; and
in response to a determination that the reduced training dataset causes the machine learning model to render a determination at least as accurate as the training dataset, validating the reduced training dataset.

12. The non-transitory machine-readable medium of claim 10, wherein the instructions for the determining the first set of the one or more datapoints that correlate with the one or more pathways that decrease the accuracy of the machine learning model outputting the label further, when executed by one or more processors, further cause the one or more processors to perform steps comprising:
determining the first set of the one or more datapoints that causes the weight associated with each node associated with the one or more pathways to change by more than a threshold amount.

13. The non-transitory machine-readable medium of claim 10, wherein each of the one or more pathways comprises a plurality of nodes that are not used in a determination to output the label based on the training dataset inputted into the machine learning model.

14. The non-transitory machine-readable medium of claim 10, wherein the training dataset is input into the machine learning model over a plurality of epochs, and wherein the instructions, when executed by one or more processors, further cause the one or more processors to perform steps comprising:
determining that the first set of the one or more datapoints causes the one or more pathways to have a net decrease in outputting the label over the plurality of epochs.

15. A computing device, comprising:
one or more processors; and
memory storing instructions that, when executed by the one or more processors, cause the computing device to:
input a training dataset into a machine learning model to train the machine learning model to output a label, wherein the machine learning model comprises a plurality of nodes and each node, of the plurality of nodes, is associated with a weight;
determine, based on one or more datapoints of the training dataset, one or more changes to the weight associated with each node of the plurality of nodes;
identify, using one or more model explainability techniques and based on the one or more changes to the weight associated with each node of the plurality of nodes, one or more pathways that decrease an accuracy of the machine learning model outputting the label;
determine a first set of the one or more datapoints that correlate with the one or more pathways that decrease the accuracy of the machine learning model outputting the label; and
remove the first set of the one or more datapoints from the training dataset to generate a reduced training dataset.

16. The computing device of claim 15, wherein the instructions, when executed by the one or more processors, further cause the computing device to:
input the reduced training dataset into the machine learning model to determine whether the machine learning model outputs the label;
compare a first label outputted by the machine learning model trained on the training dataset with a second label outputted by the machine learning model trained on the training dataset to determine whether the reduced training dataset causes the machine learning model to render a determination at least as accurate as the training dataset; and
in response to a determination that the reduced training dataset causes the machine learning model to render a determination at least as accurate as the training dataset, validate the reduced training dataset.

17. The computing device of claim 15, wherein the instructions to determine the first set of the one or more datapoints that correlate with the one or more pathways that decrease the accuracy of the machine learning model outputting the label further, when executed by the one or more processors, further cause the computing device to:
determine the first set of the one or more datapoints that causes the weight associated with each node associated with the one or more pathways to change by more than a threshold amount.

18. The computing device of claim 15, wherein each of the one or more pathways comprises a plurality of nodes that are not used in a determination to output the label based on the training dataset inputted into the machine learning model.

19. The computing device of claim 15, wherein the training dataset is input into the machine learning model over a plurality of epochs, and wherein the instructions, when executed by the one or more processors, further cause the computing device to:
determine that the first set of the one or more datapoints causes the one or more pathways to have a net decrease in outputting the label over the plurality of epochs.

20. The computing device of claim 15, wherein the instructions, when executed by the one or more processors, further cause the computing device to:
identify, using the one or more model explainability techniques and the one or more changes to the weight associated with each node of the plurality of nodes, one or more second pathways, wherein the one or more second pathways increase the accuracy of the machine learning model outputting the label;
determine a second set of the one or more datapoints that correlate with the one or more second pathways; and
generate a second reduced training dataset comprising the second set of the one or more datapoints.
